(19) United States
(12) Patent Application Publication
(10) Pub. No.: US 2026/0312873 A1
(43) Pub. Date: Oct. 8, 2026

(54) RESOURCE RELOCATION POLICY AND FUNCTION FOR DYNAMIC AND DISTRIBUTED EDGE COMPUTING RELIABILITY

(71) Applicant: InterDigital Patent Holdings, Inc., Wilmington, DE (US)

(72) Inventors: Michel Roy, Candiac (CA); Kevin Di Lallo, Laval (CA); Michael Starsinic, Newtown, PA (US); Zhibi Wang, Woodridge, IL (US); Taimoor Abbas, Sainte-Julie (CA)

(73) Assignee: InterDigital Patent Holdings, Inc., Wilmington, DE (US)

(21) Appl. No.: 19/484,162

(22) PCT Filed: May 15, 2024
(86) PCT No.: PCT/US2024/029410

§ 371 Date: Nov. 13, 2025

Related U.S. Application Data
(60) Provisional application No. 63/466,554, filed on May 15, 2023.

(51) Int. Cl. H04L 41/0894; H04L 67/1034

(52) U.S. Cl. CPC H04L 41/0894; H04L 67/1034

(57) ABSTRACT

A device may determine that one or more servers of a server set may manage consumer resources. The device may determine, based on one or more CRR rules of a CRR policy, an inter-relation indicator associated with a first consumer resource and an inter-relation indicator associated with a second consumer resource. The Inter-relation Indicator associated with the first consumer resource and the Inter-relation indicator associated with the second consumer resource may indicate whether the first consumer resource and the second consumer resource are inter-related. The device may determine a management distribution scheme based on the first inter-relation indicator and the second inter-relation indicator. The device may send notification information to a first service consumer associated with the first consumer resource and to a second service consumer associated with the second consumer resource to indicate the management distribution scheme.

### CROSS-REFERENCE TO RELATED APPLICATIONS

This application claims the benefit of Provisional U.S. Patent Application No. 63/466,554, filed May 15, 2023, the disclosure of which is incorporated herein by reference in their entireties.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Described herein are systems, methods, and instrumentalities associated with consumer resource relocation. In examples, a device (e.g., consumer resource relocation (CRR) function) may determine that one or more servers of a server set may manage consumer resources that have been managed by a server, for example, when the server becomes unavailable to manage the consumer resources. The device may determine, based on one or more CRR rules of a CRR policy (e.g., the CRR policy associated with the server that becomes unavailable), an inter-relation indicator associated with a first consumer resource and an inter-relation indicator associated with a second consumer resource. The first consumer resource may be associated with a first service consumer, and the second consumer resource may be associated with a second service consumer. The inter-relation indicator associated with the first consumer resource and the inter-relation indicator associated with the second consumer resource may indicate whether the first consumer resource and the second consumer resource are inter-related. The device may determine a management distribution scheme based on the first inter-relation indicator and the second inter-relation indicator. The device may send notification information to the first service consumer and the second service consumer to indicate the management distribution scheme. For example, the notification information may indicate a reassignment of the management of the consumer resources.

The management distribution scheme may indicate that a server from the server set is to manage at least one of the first consumer resource or the second consumer resource. In examples, the first inter-relation indicator is a first affinity value, and the second inter-relation indicator is a second affinity value. If the first affinity value is the same as the second affinity value, the management distribution scheme may indicate that a server of the server set is to manage the first consumer resource and the second consumer resource. The device may determine, based on the management distribution scheme, the server of the server set. The device may send, to the server, a request to manage the first consumer resource and the second consumer resource. The device may receive, from the server, an authorization of the request.

In examples, the first inter-relation indicator may be a first anti-affinity value, and the second inter-relation indicator may be a second anti-affinity value. If the first anti-affinity value is the same as the second anti-affinity value, the management distribution scheme may indicate that a first server of the server set is to manage the first consumer resource and that a second server of the server set is to manage the second consumer resource. The first server and the second server may be different. In some examples, an application context may be relocated. For example, if the first anti-affinity value is the same as the second anti-affinity value, the notification information may include a CRR application context relocation (ACR) triggering message indicating a relocation of an application context associated with at least one of the first service consumer or the second service consumer.

In examples, different consumer resources may be associated with different CRR rules. In examples, the first consumer resource may be associated with a first CRR rule of the CRR policy, and the second consumer resource may be associated with a second CRR rule of the CRR policy. If the first CRR rule and the second CRR rule include common consumer resource information, the management distribution scheme may indicate that a server of the server set is to manage the first consumer resource and the second consumer resource. If the first CRR rule and the second CRR rule do not include common consumer resource information, the management distribution scheme may indicate that a first server of the server set is to manage the first consumer resource and that a second server of the server set is to manage the second consumer resource.

The CRR policy in one or more examples as described herein may indicate a way in which the management of consumer resources is to be distributed among the one or more servers of the server set when the server that has been managing the consumers resources becomes unavailable. A service consumer in one or more examples as described herein may include an edge enabler client (EEC), and a consumer resource of the service consumer may include EEC context information. A service consumer in one or more examples as described herein may include an edge application server (EAS), and a consumer resource of the service consumer may include EAS profile information.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment.

FIG. 2 shows an example architecture associated with edge application(s).

FIG. 3 illustrates an example for CRR policy provisioning.

FIG. 4 illustrates an example CRR policy update.

FIG. 5 illustrates an example of a CRR policy and function system overview.

FIG. 6 illustrates an example of a consumer resource relocation using a CRR policy.

FIG. 7 illustrates an example inter-dependent consumer resource separation.

### DETAILED DESCRIPTION

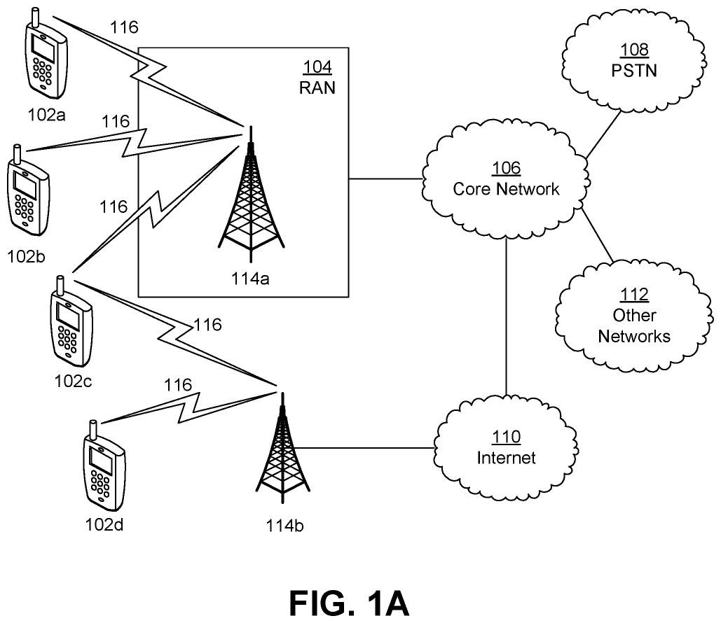

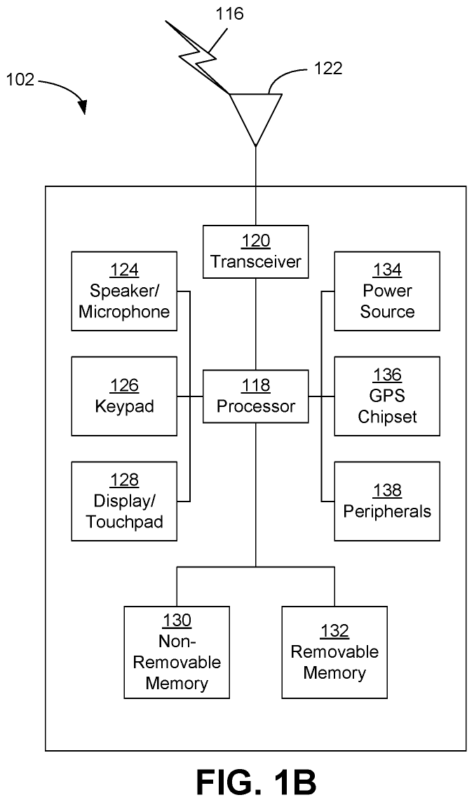

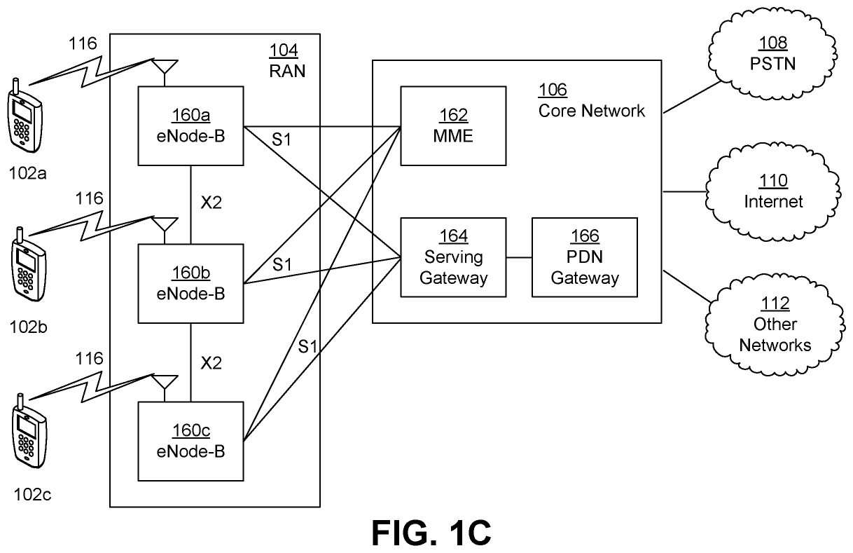

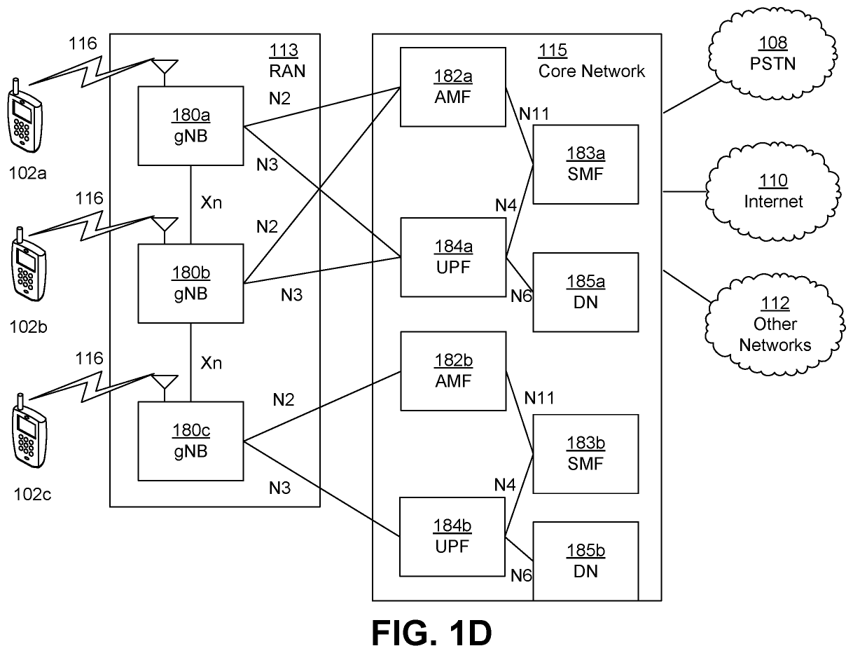

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may in other CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Described herein are systems, methods, and instrumentalities associated with consumer resource relocation. In examples, a device (e.g., consumer resource relocation (CRR) function) may determine that one or more servers of a server set may manage consumer resources that have been managed by a server, for example, when the server becomes unavailable to manage the consumer resources. The device may determine, based on one or more CRR rules of a CRR policy (e.g., the CRR policy associated with the server that becomes unavailable), an inter-relation indicator associated with a first consumer resource and an inter-relation indicator associated with a second consumer resource. The first consumer resource may be associated with a first service consumer, and the second consumer resource may be associated with a second service consumer. The inter-relation indicator associated with the first consumer resource and the inter-relation indicator associated with the second consumer resource may indicate whether the first consumer resource and the second consumer resource are inter-related. The device may determine a management distribution scheme based on the first inter-relation indicator and the second inter-relation indicator. The device may send notification information to the first service consumer and the second service consumer to indicate the management distribution scheme. For example, the notification information may indicate a reassignment of the management of the consumer resources.

The management distribution scheme may indicate that a server from the server set is to manage at least one of the first consumer resource or the second consumer resource. In examples, the first inter-relation indicator is a first affinity value, and the second inter-relation indicator is a second affinity value. If the first affinity value is the same as the second affinity value, the management distribution scheme may indicate that a server of the server set is to manage the first consumer resource and the second consumer resource. The device may determine, based on the management distribution scheme, the server of the server set. The device may send, to the server, a request to manage the first consumer resource and the second consumer resource. The device may receive, from the server, an authorization of the request.

In examples, the first inter-relation indicator may be a first anti-affinity value, and the second inter-relation indicator may be a second anti-affinity value. If the first anti-affinity value is the same as the second anti-affinity value, the management distribution scheme may indicate that a first server of the server set is to manage the first consumer resource and that a second server of the server set is to manage the second consumer resource. The first server and the second server may be different. In some examples, an application context may be relocated. For example, if the first anti-affinity value is the same as the second anti-affinity value, the notification information may include a CRR application context relocation (ACR) triggering message indicating a relocation of an application context associated with at least one of the first service consumer or the second service consumer.

In examples, different consumer resources may be associated with different CRR rules. In examples, the first consumer resource may be associated with a first CRR rule of the CRR policy, and the second consumer resource may be associated with a second CRR rule of the CRR policy. If the first CRR rule and the second CRR rule include common consumer resource information, the management distribution scheme may indicate that a server of the server set is to manage the first consumer resource and the second consumer resource. If the first CRR rule and the second CRR rule do not include common consumer resource information, the management distribution scheme may indicate that a first server of the server set is to manage the first consumer resource and that a second server of the server set is to manage the second consumer resource.

The CRR policy in one or more examples as described herein may indicate a way in which the management of consumer resources is to be distributed among the one or more servers of the server set when the server that has been managing the consumers resources becomes unavailable. A service consumer in one or more examples as described herein may include an edge enabler client (EEC), and a consumer resource of the service consumer may include EEC context information. A service consumer in one or more examples as described herein may include an edge application server (EAS), and a consumer resource of the service consumer may include EAS profile information.

Reference to a timer herein may refer to a time, a time period, a tracking of time, a tracking of a period of time, a combination thereof, and/or the like. Reference to a timer expiration herein may refer to determining that the time has occurred or that the period of time has expired.

Described herein are systems, methods, and instrumentalities associated with consumer resource reassignments based on an evaluation of a consumer resource relocation (CRR) policy.

For example, a device may perform a consumer resource reassignment based on an evaluation of a CRR policy. The device may receive a request associated with CRR policy provisioning. The device may perform a consumer resource reassignment based on a determination of an unavailability of a server and based on the evaluation of the CRR policy. The device may send an indication of the consumer resource reassignment and receive a response to the sent indication.

In examples, the device may include a CRR function. The CRR function may receive CRR policy provisioning request(s) or request(s) containing CRR rule(s) (e.g., request(s) equivalent to CRR policy provisioning request(s). For example, a CRR rule may include one or more of the following: a server identifier (e.g., an active server identifier), a server set, a server set identifier, consumer resource information, and/or resource relocation information. The CRR function may store the received CRR rule(s) as a CRR policy and/or issue a CRR rule identifier for a CRR rule and a CRR policy identifier for a CRR policy (e.g., CRR rule identifiers and CRR policy identifiers for each CRR rule and CRR policy). The CRR function may send CRR policy provisioning response(s). The response(s) may include CRR rule identifier(s) and CRR policy identifier(s).

The CRR function may detect unavailability of a server (e.g., unavailability of an active server). The CRR function may evaluate the CRR policy, for example, to perform consumer resource reassignments. The evaluation of the CRR policy may include one or more of the following: considering if a rule applies to an alternate server; obtaining a server set; considering if one or more alternate servers of the server set may be used (e.g., based on one or more of the following: an ECSP of an alternate server; topological service areas associated with the alternate server; a geographical service area associated with the alternate server; a time period associated with the alternate server; a server load and service specific requirements associated with the alternate server); performing consumer resource assignments based on one or more of the following: the identified alternate servers; consumer resources; consumer resources affinity and/or anti-affinity. The CRR function may send CRR migration notification(s) or request(s), for example, to the alternate server(s) of a server set. For example, the notification(s) or request(s) may include resource identifiers of resources (e.g., resources managed by the unavailable active server). The CRR function may receive CRR migration response(s), for example, from the alternate server(s). For example, a CRR migration response may indicate that the consumer resource(s) has been successfully migrated. The CRR function may send CRR execution notification(s) or request(s), for example, to consumer(s). For example, the notification(s) or request(s) may include alternate server identifier(s). The CRR function may receive CRR execution response(s), for example, from the consumer(s). For example, a CRR execution response may indicate that the consumer has accepted the alternate server.

Described herein are systems, methods, and instrumentalities associated with separating inter-dependent consumer resources, based on a determination that the inter-dependent consumer resources are to be separately relocated (e.g., to different servers).

For example, a device may determine that inter-dependent consumer resources are to be separately relocated and may send a request to separate the inter-dependent consumer resources based on the determination that the inter-dependent consumer resources are to be separately relocated. The device may receive a response to the request wherein the response may indicate a reception of the request.

In examples, the device may include a consumer resource relocation (CRR) function. The CRR function may determine that inter-dependent resources are to be separated and/or dissociated for relocation (e.g., some or all of the inter-dependent resources cannot be co-relocated). The CRR function may send, for example, based on the determination of the separation and/or disassociation of the inter-dependent resources, CRR ACR notification(s) or request(s). The CRR ACR notification(s) or request(s) may be sent to one or more of the following: a WTRU (e.g., a UE); an EEC; an EAS; an EES, for example, to break the resource inter-dependency. For example, the notification(s) or request(s) may include some or all of the following: a WTRU identifier (e.g., a UE identifier); an EEC identifier; an EAS identifier; an EAS endpoint; an EES identifier. The CRR function may receive CRR ACR response(s), for example, from one or more of the following: a WTRU; an EEC; an EAS; an EES. For example, a CRR ACR response may indicate that the notification(s) has been received. The CRR function may observe messaging indicating that an ACR is executing (e.g., the ACR is executing for the WTRU (e.g., UE) and EAS pair identified in the CRR ACR notification or request).

In some examples, a device may receive a consumer resource relocation (CRR) application context relocation (ACR) request and determine whether an ACR is to be initiated based on an ACR capability, a selected ACR scenario, and the CRR ACR request. The device may, based on a determination that the ACR is to be initiated, initiate the ACR or send a request to initiate the ACR. The device may include a consumer or an alternate server.

The consumer or alternate server may receive a CRR ACR notification or request from a CRR function, for example. The notification or request may include some or all of the following: a WTRU identifier (e.g., a UE identifier), an EEC identifier, an EAS identifier, an EAS endpoint; an EES identifier.

The consumer or alternate server may evaluate if ACR execution may be initiated. The evaluation may be based on one or more of the following: ACR capabilities, selected ACR scenarios (e.g., one or more of the scenarios or examples as described herein); CRR notification or request information. If ACR execution may be initiated, the consumer or alternate server may initiate ACR execution and/or send an ACR request to the alternate server that is included in the CRR ACR notification or request, for example. The ACR request may include some or all of the following: a WTRU identifier (e.g., a UE identifier), an EEC identifier, an EAS identifier, an EAS endpoint; an EES identifier. The consumer or alternate server may observe messaging indicating ACR execution (e.g., the ACR execution for the WTRU and EAS pair identified in the CRR ACR notification or request). ACR execution messaging may include one or more messages indicating any of the following: that a target EES has been selected for the WTRU and EAS pair, that a target EAS has been selected for the WTRU and EAS pair, that an EEC context has been transferred from a source EES to a target EES; that an application context has been transferred from a source EAS to a target EAS.

In one or more examples, reliability may be improved by performing one or more actions as described herein. For example, by enabling controlled relocation of consumer resources to multiple alternate servers, by managing inter-dependent consumer resource(s), and/or by supporting cases where inter-dependent consumer resources are to be separated for relocation (e.g., where inter-dependent consumer resources cannot be co-relocated).

A resource relocation policy and/or function (e.g., a CRR policy and/or function) may include or define one or more rules for relocating consumer resources (e.g., independent consumer resources). The resource relocation policy may be dynamically managed (e.g., as described in one or more examples herein). One or more examples as described herein show how the resource relocation policy may be dynamically managed. The resource relocation policy may be applied in an edge network (e.g., including distribution of resources management to one or more alternate servers according to rules, as described in one or more examples herein). One or more examples as described herein may show how the resource relocation policy may be applied in an edge network.

Resources (e.g., inter-dependent edge resources) may be jointly relocated to a common server (e.g., a common alternate server) or relocated to a different server (e.g., one or more different alternate servers). For example, inter-dependent edge resources may be jointly relocated to a common server (e.g., an alternate server) based on their affinity, and/or inter-dependent edge resources may be relocated to a different server (e.g., different alternate servers) based on their anti-affinity (e.g., the inter-dependent edge resources may be jointly relocated to a common server based on their affinity or relocated to different alternate server(s) based on their anti-affinity). Some inter-dependent resources may not be relocated to a common alternate server. One or more examples described herein describe how a relocation of such inter-dependent resources is performed in an edge network.

A consumer resource relocation (CRR) function may be implemented in at least one of the following: an edge enabler server (EES), an edge configuration server (ECS), or an independent server. A server (e.g., an alternate server) may be an EES or an ECS. A consumer (e.g., a service consumer) may be at least one of a WTRU (e.g., a UE), an EEC, an EAS, or an EES. For example, for a service consumer that is an EEC, a consumer resource associated with the service consumer may include EEC context information. For a service consumer that is an EAS, a consumer resource associated with the service consumer may include EAS profile information.

A CRR policy and/or a CRR function may be used in one or more examples described herein. A CRR function may perform one or more actions to relocate consumer resources (e.g., according to a management distribution scheme associated with one or more servers). For example, a device may determine that, when a reliability event occurs, management of consumer resources is to be distributed across one or more servers (e.g., one or more alternate servers or alternative server instances) of a server set. The reliability event may be that a server (e.g., an active server) that has been managing one or more consumer resources becomes unavailable to manage the one or more consumer resources.

The CRR function may receive CRR policy provisioning request(s) or request(s) containing CRR rule(s) (e.g., request(s) equivalent to CRR policy provisioning request(s). For example, a CRR rule may include one or more of the following: a server identifier (e.g., an active server identifier), a server set, a server set identifier, consumer resource information, and/or resource relocation information. The CRR function may store the received CRR rule(s) as a CRR policy and/or issue a CRR rule identifier for a CRR rule and a CRR policy identifier for a CRR policy (e.g., CRR rule identifiers and CRR policy identifiers for each CRR rule and CRR policy). The CRR function may send CRR policy provisioning response(s). The response(s) may include CRR rule identifier(s) and CRR policy identifier(s). The CRR function may detect unavailability of a server (e.g., an active server unavailability).

The device may determine, based on one or more CRR rules of a CRR policy (e.g., a CRR policy associated with the server that becomes unavailable), a management distribution scheme associated with a server set (e.g., a server set that includes one or more alternative servers to the server that becomes unavailable). The management distribution scheme may indicate how the management of consumer resources is distributed among alternate server instances of a server set. In examples, the device (e.g., a CRR function) may evaluate a CRR policy, for example, to perform consumer resource reassignments. The evaluation of the CRR policy (e.g., the CRR policy associated with the server that becomes unavailable) may include considering if a rule (e.g., a CRR rule) applies to an alternate server (e.g., a server of the server set). The evaluation of the CRR policy may include obtaining a server set. The evaluation of the CRR policy may include considering if one or more servers (e.g., alternate servers) of the server set may be used, which may be based on at least one of an ECSP of a server (e.g., an alternate server), a topological service area associated with the server (e.g., the alternate server), a geographical service area associated with the server (e.g., the alternate server), a time period associated with the server (e.g., the alternate server), a server load associated with the server (e.g., the alternative server), or a service specific requirement associated with the server (e.g., the alternate server). The evaluation of the CRR policy may include performing consumer resource assignments based on at least one the identified servers (e.g., alternate servers), the consumer resources, or the consumer resources inter-relations (e.g., affinity and/or anti-affinity).

The device (e.g., a CRR function) may determine, based on the management distribution scheme, a server of the server set to manage one or more consumer resources (e.g., inter-related consumer resources). The device may send to the server of the server set (e.g., an alternate server to the server that becomes unavailable), a request to manage the one or more consumer resources. In examples, the device may send CRR migration notification(s) or request(s) to the alternate server(s) in a server set. For example, the notification(s) or request(s) may include resource identifiers of resources (e.g., consumer resources managed by the unavailable active server).

The device (e.g., a CRR function) may receive, from the second server, an authorization of the request. In examples, the device may receive CRR migration response(s), for example, from one or more servers (e.g., the alternate servers). For example, a CRR migration response may indicate that the consumer resource(s) has been successfully migrated.

The device (e.g., a CRR function) may send notification information to service consumers (e.g., a first service consumer associated with a first consumer resource and a second service consumer associated with a second consumer resource). The notification information may indicate the management distribution scheme. For example, the notification information may indicate a reassignment of the management of the one or more consumer resources. In examples, the device may send CRR execution notification(s) or request(s) to consumer(s) (e.g., service consumers associated with inter-related resources). The CRR execution notification(s) or request(s) may include alternate server identifier(s). The device may receive CRR execution response(s), for example, from the consumer(s). For example, a CRR execution response may indicate that the consumer has accepted the alternate server.

Inter-related resources (e.g., inter-dependent edge resources) may be separated in one or more examples herein. A device (e.g., a CRR function) may perform one or more actions to perform inter-dependent resource separation. The device may determine that inter-dependent resources are to be separated and/or dissociated for relocation (e.g., some or all of the inter-dependent resources cannot be co-relocated). The device may send, for example, based on the determination of the separation and/or disassociation of the inter-dependent resources, CRR ACR notification(s) or request(s). The CRR ACR notification(s) or request(s) may be sent (e.g., to one or more of the following: a WTRU, an EEC, an EAS, and an EES), for example, to break the resource inter-dependency. For example, the CRR ACR notification(s) or request(s) may include some or all of the following: a WTRU identifier (e.g., a UE identifier), an EEC identifier, an EAS identifier, an EAS endpoint, or an EES identifier. The device may receive CRR ACR response(s), for example, from one or more of the following: a WTRU, an EEC, an EAS, and an EES. For example, a CRR ACR response may indicate that the notification(s) has been received. The device may monitor for an indication (e.g., observe messaging) indicating that an ACR is executing (e.g., the ACR is executing for the WTRU and EAS pair identified in the CRR ACR notification or request).

A consumer or a server (e.g., an alternate server) may perform one or more of the following actions (e.g., for inter-dependent resource separation). The consumer or the server (e.g., the alternate server) may receive a CRR ACR notification or request, for example, from a CRR function. For example, the CRR ACR notification or request may include some or all of the following: a WTRU identifier (e.g., a UE identifier), an EEC identifier, an EAS identifier, an EAS endpoint, or an EES identifier. The consumer or server may evaluate if ACR execution may be initiated. The evaluation may be based on (e.g., only) one or more of the following: ACR capabilities, selected ACR scenarios (e.g., one or more of the scenarios or examples as described herein), CRR notification, or request information. If ACR execution may be initiated, the consumer or alternate server may initiate ACR execution and/or send an ACR request, for example, to the server that is included in the CRR ACR notification or request. For example, the ACR request may include some or all of the following: a WTRU identifier (e.g., a UE identifier), an EEC identifier, an EAS identifier, an EAS endpoint, or an EES identifier. The consumer or server (e.g., alternate server) may monitor for an indication (e.g., observe messaging) indicating ACR execution (e.g., the ACR execution for the WTRU and EAS pair identified in the CRR ACR notification or request). The indication (e.g., ACR execution messaging) may include one or more messages indicating any of the following: that a target EES has been selected for the WTRU and EAS pair, that a target EAS has been selected for the WTRU and EAS pair, that an EEC context has been transferred from a source EES to a target EES, or that an application context has been transferred from a source EAS to a target EAS.

An ACR scenario may include, for example, a service continuity procedure that is executed with the purpose of replacing an EAS instance used by a WTRU with a different EAS instance in a transparent manner to the user such that the service consumed by the user is not broken. Different ACR scenarios (e.g., procedures) with variations and/or flavors may have been used or defined, and nodes of the edge system may support a variation and/or flavor (e.g., may need to support each variation and/or flavor).

ACR capabilities may be provided by the node(s) of the edge system to indicate which ACR procedure variations and/or flavors are supported by that node(s). In examples, to offer service continuity between an AC executing on a WTRU and an EAS executing in the network, an ACR procedure variation and/or flavor may be supported by one or more of the AC, EEC, EES, and/or EAS. The ACR procedure variation and/or flavor may be supported by some or all of the AC, EEC, EES, and EAS. A selection of ACR may occur (e.g., may need to happen) and the selection may consider (e.g., may need to take into account) ACR capabilities one or more of the AC, EEC, EES, and EAS.

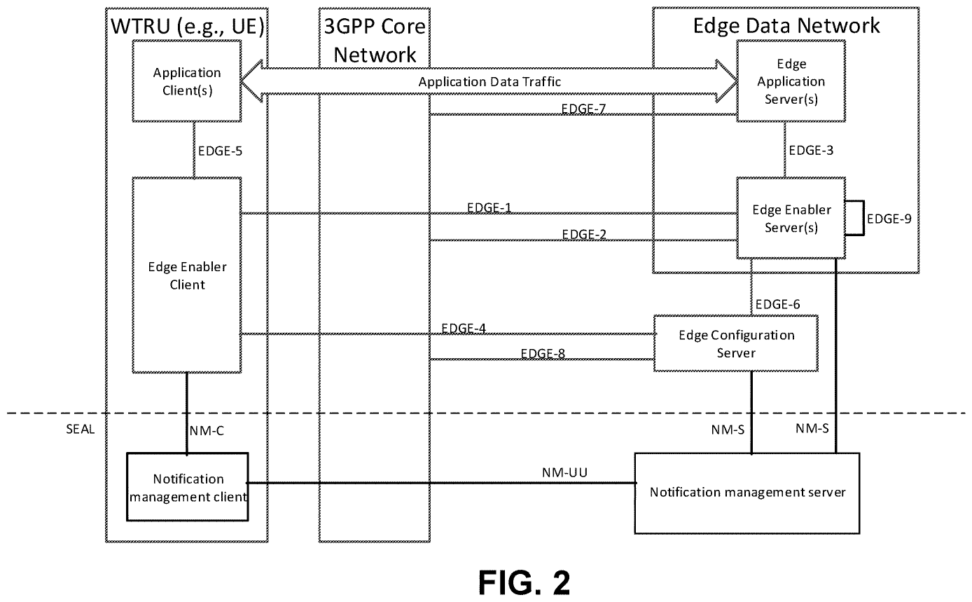

Application layer architecture may be used in one or more examples as described herein, for example, for supporting edge services. FIG. 2 shows an example architecture associated with edge application(s). The example architecture shown in FIG. 2 may be an SA6 architecture and a high-level one. The example architecture shown in FIG. 2 may be used for enabling edge application(s).

The example architecture in FIG. 2 may depict an edge enablement layer (EEL) that allows applications on a WTRU to consume edge services from a mobile network. The core functionality offered by the EEL may be allowing a WTRU to be provisioned with edge connectivity information, for example, to discover available edge services and/or to maintain edge service while moving through the mobile network.

The example architecture in FIG. 2 may include one or more components. An application client (AC) may include a user application residing on a WTRU that communicates with an EAS. A WTRU may use one or more AC (e.g., may use multiple AC concurrently). An edge application server (EAS) may include an application server resident in an EDN (e.g., it may be a software server executing on generic hardware located at the edge and providing a service to the AC). In the context of a mobility/relocation use case, the source-EAS (S-EAS) may include an instance of an EAS in an initial location and serving the AC before mobility/relocation happens, and the target-EAS (T-EAS) may include an instance of an EAS in a destination location and serving the AC after mobility/relocation has happened. There may be multiple EAS instances per EDN. An EDN (e.g., each EDN) may contain a different set of EAS instances of different types (e.g., different EASID). An EAS may serve one or more AC instances that may reside on different WTRUs. An edge enabler client (EEC) provides edge support, for example, to the AC instances on the WTRU. There may be one or more EEC per WTRU. An AC may use an EEC (e.g., each AC uses only one EEC). An edge enabler server (EES) provides supporting functions (e.g., supporting functions needed by EAS and EEC). In the context of a mobility/relocation use case, the source-EES (S-EES) may include the EES used before mobility/relocation happens, and the target-EES (T-EES) may include the EES used after mobility/relocation has happened. There may be one or more EES instances per EDN (or per DNN). There may be one or more (e.g., multiple) EDN instances in the network. An edge configuration server (ECS) may provide supporting functions for an EEC or EES, for example, to discover EES instances providing certain EAS. There may be one or more ECS for the network. A notification management client (NMC) may provide supporting functions for an EEC, for example, to create a notification channel between the NMC and the NMS to receive notifications from the ECS or EES. An EEC may use an NMC (e.g., each EEC uses only one NMC). A notification management server (NMS) may provide supporting functions for an ECS or EES, for example, to send notifications to an EEC via a notification channel created between the NMC and the NMS. There may be one or more NMS for the network.

Passive and/or active resources may be used in one or more examples described herein. A passive resource may represent information stored on a server. A passive resource may consume storage (e.g., memory, disk space) resources of the server. The information associated with the passive resource may be one or more of the following or used in one or more of the following ways: may be used internally by the server; may be accessible externally through a server API; may change over a period of time; may be information related to internal states of the server; or may be information related to external clients of the server. Passive resources in the EES may include: the EEC context created when an EEC registers to an EES, the EAS profile created when an EAS registers to an EES, and the various subscriptions created when EES clients (e.g., EEC, EAS, EES) subscribe to EES event notifications. Passive resources in the ECS may include one or more of the following: the EES profile created when an EES registers to an ECS, and one or more subscriptions created when ECS clients (e.g., EEC, EES, ECS) subscribe to ECS event notifications.

An active resource may represent one or more actions performed on a server. For example, an active resource may consume processing and/or networking resources of the server. The actions associated with the active resource may include one or more of the following: may be triggered by internal server operations, may be triggered by interaction with an external client through an API, may vary over a period of time, may request (e.g., require) temporary execution and/or communication, and may request (e.g., require) constant or periodic execution/communication. Active resources in the EES may include one or more of the following: the event detection related to subscriptions created by EES clients (e.g., EEC, EAS, EES), the application context relocation (ACR) event detection and/or processing that may be initiated at the EES and related to an application client (AC) communicating with an EAS, and the 5GS periodic events (e.g., WTRU location) that may be requested from the 5GS by the EES. Active resources in the ECS may include one or more of the following: the event detection related to one or more subscriptions created by ECS clients (e.g., EEC, EES, ECS), one or more periodic events (e.g., a location of a WTRU and/or other 5GS periodic events) that may be requested from the core network by the ECS.

Inter-related resources (e.g., inter-dependent resources) may be used in one or more examples herein. In examples, different consumer resources may be inter-dependent and/or may be relocated together (e.g., may need to be co-relocated together, for example, to the same server/server instance). In examples, inter-dependent resources may be based on and/or may be caused by the relationships that an edge system (e.g., 5G edge system) imposes between the WTRU and the EAS instance(s) being used by the WTRU. For example, the WTRU may use and/or may register with the EES associated with EAS instances being used by the WTRU (e.g., with the EES instance where the EAS instances are registered) to enable certain procedures. In examples (e.g., a scenario that requires reliable communications), consumer resource(s) associated with a first consumer (e.g., a WTRU) may need to be co-relocated with consumer resource(s) associated with a second consumer (e.g., the EAS instances used by the same WTRU), for example, to preserve the same common EES.

In examples, interdependent resources may be based on and/or caused by the relationship between a group of WTRUs and a common EAS in a collaborative scenario. For example, a group of WTRUs may need to communicate with a common EAS to perform a collaborative task (e.g., a task that requires ultra-low latency, for example, gaming, remote surgery, etc.). In examples (e.g., a scenario that requires ultra-low latency), the consumer resources of consumers (e.g., the WTRUs and the shared common EAS instance) may need to be co-relocated, for example, to preserve the requested (e.g., required) communication network performance characteristics. In examples, interdependent resources may be based on and/or caused by the relationship between EAS(s) of an EAS bundle (e.g., a group of EAS instances) and a WTRU that may be associated with the EAS bundle. The EAS instances of an EAS bundle may need to communicate together (e.g., it may be necessary to co-relocate these resources together to preserve the bundle characteristics).

In examples, such as some edge reliability scenarios, consumer resources that are co-located on a server instance (e.g., a single server instance) that provides a service may be relocated across multiple server instances that provide a service. For example, this may prevent a server overloading scenario. In examples, a system (e.g., a 5G system) may not support mechanisms for providing reliable edge computing (e.g., the ability to maintain service in case an ECS or EES becomes unavailable). This may happen for one or more of the following reasons: failure, maintenance, connectivity issues, high server load, etc. Reliable edge computing may help improve edge system reliability, robustness, and/or predictability. Reliable edge computing may help maximize user experience, for example, by minimizing downtime.

An increased reliability in an edge enablement layer may be possible by using one or more server sets. A server set may include alternative servers (e.g., pre-defined alternative server instances) for replacing a server providing a service when the server or the service, or both, become unavailable. A provider (e.g., a server instance providing a service) may be an ECS and/or an EES. The provider's service may be used by one or more of the following consumers: a WTRU, an EEC, an EAS, or an EES. In examples, a service may be offered by an application executing on a server (e.g., in a first scenario where the application may terminate, crash, be taken offline, etc., making the service unavailable, but the server may remain available; in a second scenario, the server may be terminated, making the service unavailable). In examples described herein, a server may become unavailable (e.g., server unavailability may indicate service unavailability, and/or service unavailability may indicate server unavailability; in one or more examples server unavailability, service unavailability or the combination of server and service unavailability may be used interchangeably).

Consumer resources that are co-located on a server instance may be relocated to different alternate server instances, for example, to prevent an alternate server instance overload and/or when a consumer may be located outside the service area of alternate server instances.

One or more examples herein describe how consumer resources located on a server providing a service may be relocated across multiple alternate servers and/or how the relocation information may be maintained as an edge system (e.g., the 5G edge system) server availability changes.

One or more examples herein describe how interdependent consumer resources, located on a server providing a service, are to be relocated together to a common alternate server. One or more examples herein describe how these interdependent consumer resources may be identified in an edge network.

One or more examples herein describe how to handle the case where inter-dependent resources located on a server providing a service may be separately relocated (e.g., these inter-dependent resources may be unable to be relocated to a common alternate service provider server).

In one or more examples as described herein, a consumer resource may include data that may be related to a consumer and/or associated with an active server. The data may be information related to the consumer and/or may comprise information indicating to the server that certain processing at the server may be expected by the consumer. The data may physically be stored at the active server or stored in a shared repository that may be accessible to other servers. In one or more examples as described herein, an active server may include a server instance (e.g., EES or ECS) associated with a server set; the active-server instance may be used by consumer node(s) and/or manage consumer resources. An alternate server may include a server instance (e.g., EES or ECS) associated with a server set; the alternate server instance may be an active server. The alternate server instance may include a possible replacement server for a peer-active server and/or may be capable of managing consumer resources from that peer-active server. A consumer node may include a node instance (e.g., WTRU, EEC, EAS, and/or EES) that consumes service(s) from an active server instance associated with a server set.

There may be instances where consumer resources are stored within an active server and relocated to one or more server instances (e.g., alternate server instances). These instances may be applicable to the planned unavailability scenarios. Copying a large number of consumer resources may be time-consuming and/or limited by the network (e.g., creating inefficiency).

There may be instances where consumer resources are stored within a common storage (e.g., one that may be accessed by multiple servers). These instances may be applicable (e.g., as an assumption) to one or more examples as described herein. These instances may be applicable to planned and unplanned unavailability scenarios, and/or may eliminate the need to copy consumer resources, In a shared storage model, relocating or distributing consumer resources may include transferring responsibility for managing the consumer resources from a server/server instance to another server/server instance.

Reliable edge computing may allow the system to continue to maintain service in case an ECS or EES becomes unavailable (e.g., failure, maintenance, connectivity issue, high server load, etc.). Reliable edge computing features may improve edge system reliability, robustness, and/or predictability, for example, to maximize user experience by minimizing downtime.

One or more examples herein may allow improved reliability based on one or more of the following: for example, by enabling the controlled relocation of consumer resources across multiple alternate servers, by managing inter-dependent consumer resources, or by supporting cases where inter-dependent consumer resources are to be separately relocated (e.g., these inter-dependent consumer resources cannot be co-relocated).

A consumer resource relocation (CRR) policy and/or function may be used in one or more examples herein. A CRR policy may indicate how the management of consumer resources (e.g., the consumer resources managed by an active server) are distributed across alternate server instances of a server set when a reliability event happens. A CRR policy may include one or more CRR rules. A CRR rule (e.g., each CRR rule) may include one or more of the following information: an active server identifier for which the CRR policy applies (e.g., an active server identifier may be an EES identifier [e.g., EESID] or ECSs connectivity information [e.g., IP address, universal resource identifier (URI), fully qualified domain name (FQDN])); a server set or identifier of a server set that indicates a list of one or more serve (e.g., alternate) server instances to be considered when evaluating CRR policy; consumer resource information providing consumer resource details (e.g., identity, type, URI) for which the relocation rule applies; and relocation information providing information on how to relocate the consumer resources to the servers (e.g., alternate servers) of the server set.

In examples, a CRR rule may indicate the consumer resources (e.g., all consumer resources) of an active server and/or may indicate to distribute the consumer resources among the alternate servers of the server set (e.g., equally distribute the consumer resources among all alternate servers of the server set). In some examples, a CRR rule may indicate that specific consumer resources of an active server (e.g., allone or more resources of EAS instances that require a graphical processing unit (GPU) and/or may indicate to relocate these to an alternate server (e.g., a specific alternate server of the server set that may be with GPU capabilities).

A CRR rule, a server set within a CRR rule, or a server set identified in a CRR rule may include additional information. For example, the additional information may include additional configuration data. Additional configuration data may include one or more of the following: active server identifier(s) (e.g., EESID or ECS IP address or ECS URI or ECS FQDN or public land mobile network (PLMN)), which identify active server(s) to which the server set may be applicable; connectivity information (e.g., data network name (DNN), access point name (APN), single network slice selection assistance information (S-NSSAI) for a server instance (e.g., each server instance) of the server set, which identifies how to establish connectivity to server(s) of the server set; EES endpoint information (e.g., IP address/URI/FQDN), which identifies the endpoint information associated with an EESID (e.g., each EESID); edge computing service provider (ECSP) information (e.g., ECSP identifier) associated with the server set or with a server (e.g., each server) of the server set indicating a validity condition based on ECSP; service area information (e.g., topological, geographical) associated with the server set or associated with a server instance (e.g., each server instance) of the server set indicating a validity condition based on geography or network topology; a time period associated with the server set or with a server (e.g., each server) of the server set indicating a server set or server availability condition based on time (e.g., indicates periods when the server set or the server of the server set may be used); server priority information associated with a server (e.g., each server) of the server set indicating in which order the servers are to be considered when the active server fails; service specific identifier(s) indicating that the CRR rule or server set, or server set identifier may be associated with to a service (e.g., the service identifier(s) may be coupled with priority information such that the CRR rule or server set, or server set identifier may be prioritized when evaluated).

A CRR function may be provisioned with a CRR policy. It may offer CRR policy management. it may apply the CRR policy when a reliability event happens. In one or more examples, as described herein, the CRR function may be performed by an active server node, alternate server(s) nodes, an independent node, or by consumer nodes. For example, in an edge architecture (e.g., 5G system edge architecture), these nodes may be the EES, ECS, or consumer nodes (e.g., WTRU, EEC, EAS).

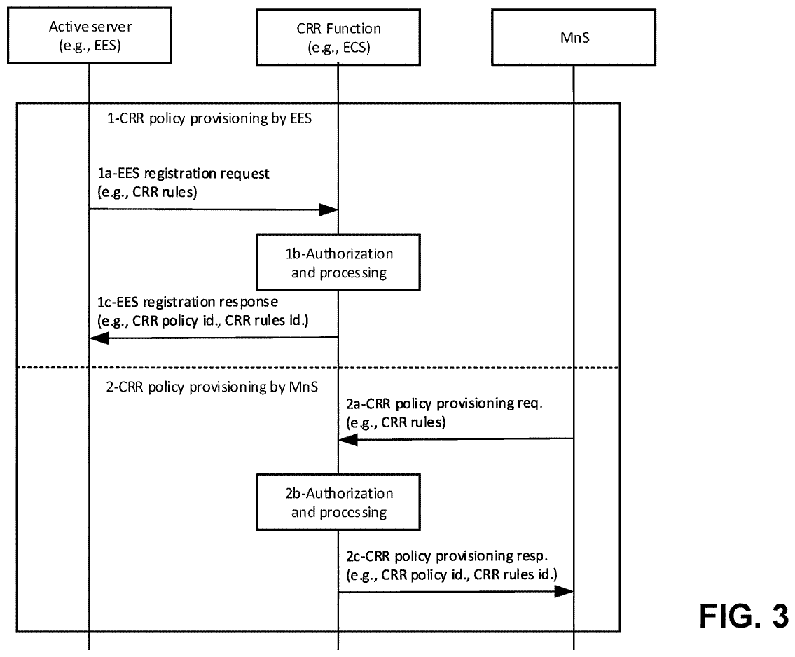

A CRR policy may be provisioned. A CRR policy may be provisioned to a CRR function, for example, during the configuration of the CRR function. Policy provisioning may originate from different sources, for example, depending on the chosen system architecture and/or roles. Policy provisioning may be offered (e.g., via an API of the CRR function or by combining with existing API operations by adding CRR policy information). CRR policy provisioning may be further described in one or more examples herein (e.g., in FIG. 3).

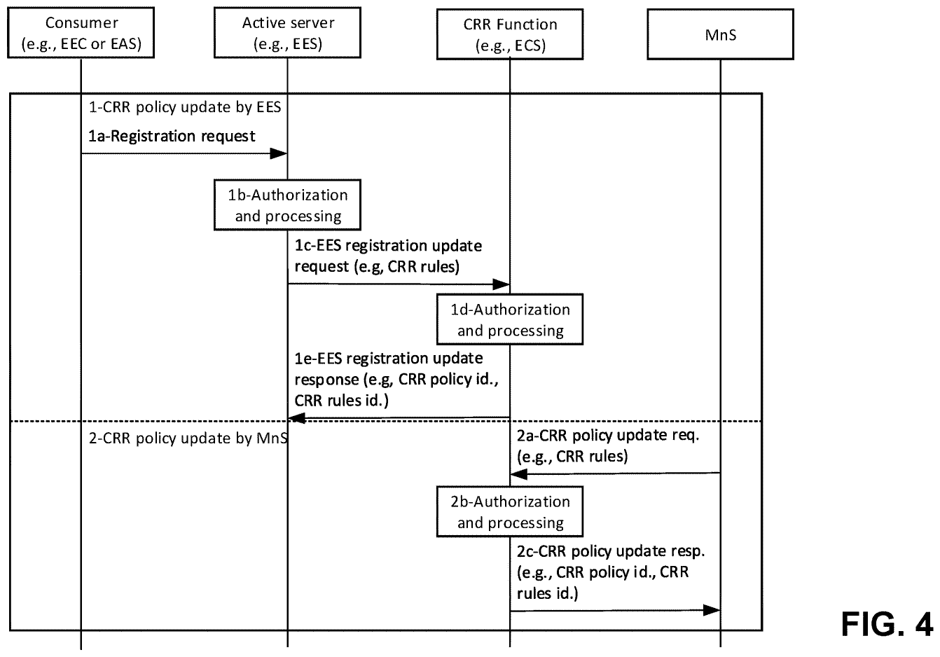

A CRR policy may be maintained. In examples, a CRR policy may need to remain aligned with its corresponding deployment (e.g., active server, alternate server, etc.). For example, when the deployment changes, the CRR policy may need to be updated accordingly by the CRR function. In examples, when active servers become unavailable, the CRR policy may be deleted. CRR policy maintenance may be further described in one or more examples as described herein (e.g., in FIG. 4).

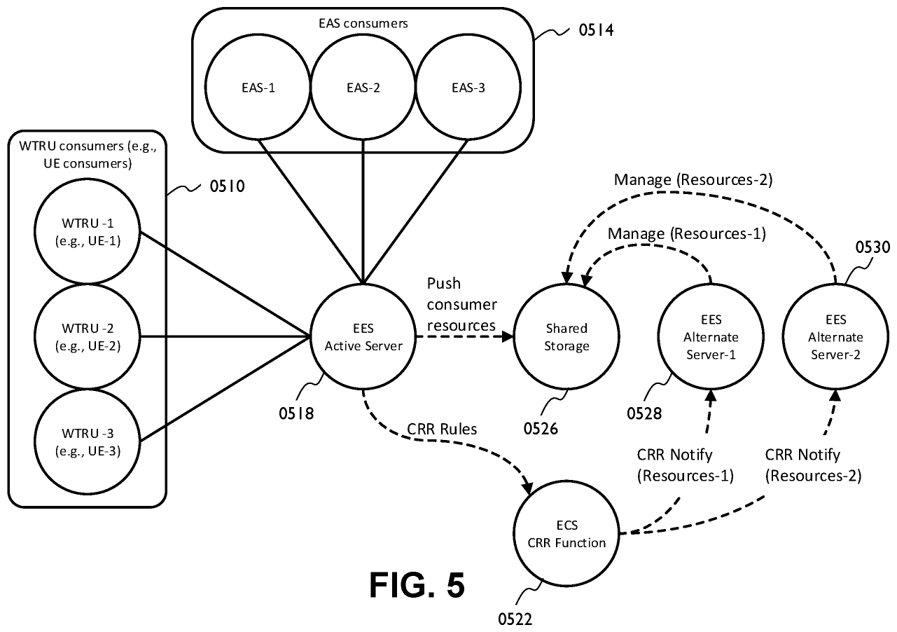

A CRR policy may be applied. When an active server becomes unavailable, the CRR function may (e.g., may need to) detect or be informed of the change, for example, to trigger the evaluation and/or application of the CRR policy. Based on a triggering event, the CRR function may (e.g., may need to) evaluate the CRR policy, inform the alternate server that there has been a change in the management of the resources, and/or perform maintenance of the CRR policy according to the triggering event. CRR policy application may be further described in one or more examples as described herein (e.g., in FIG. 5).

CRR policy and function procedures may be described in one or more examples herein. A CRR policy may be provisioned. FIG. 3 illustrates an example of CRR policy provisioning. FIG. 3 presents an edge system where the CRR function may be provided by an ECS and where the CRR policy rules may be provided by the EES or the management system (MnS). In examples, CRR rules may be provisioned to the ECS by the EES. In some examples, CRR rules may be provisioned to the ECS by the MnS.

Multiple CRR policy provisioning embodiments may happen in the same system. For example, an EES may provide CRR rules to the ECS, and the MnS may provide additional CRR rules to the ECS.

At 1, one or more CRR policy rules may be provisioned to the ECS by the EES. At 1a, the EES (e.g., as an active server) may send an EES registration request (1a) to the ECS (e.g., as the CRR function). The EES registration request may include the EES profile and/or may include CRR rule(s) to be included in the CRR policy of the ECS for the EES instance sending the request. A CRR rule (e.g., each CRR rule) may include one or more of the following: the EESID of the EES making the request, a server set, an identifier of a server set, consumer resource information (e.g., type of resource, resource URI) that identifies consumer resource(s) (e.g., resources associated with the EESID that are to be managed via the CRR policy) and relocation information (e.g., information indicating how and where to relocate consumer resources).

Upon receiving the EES registration request at 1b, the ECS may authorize the request, store the EES profile, and save the CRR rules in the CRR policy. The ECS may validate the CRR rules according to one or more of the following: for example, the ECS may validate if the active server identifier of the CRR rule matches the registering EES; the ECS may validate if the server set may have been provided or if a server set may be retrieved if a server set identifier has not provided; the ECS may validate if consumer resource information and relocation information have been provided. The ECS may assign a CRR rule identifier and a CRR rule origin corresponding to the requestor that provided the CRR rule.

The ECS may send an EES registration response at 1c and/or may indicate a failure and a reason for a failure (e.g., failed authorization, failed CRR rules validation, etc.) if the CRR rules validation failed. If the request was successful, the response may indicate CRR rules identifiers and a CRR policy identifier for future management of CRR policy and rules.

At 2, one or more CRR policy rules may be provisioned to the ECS by the MnS. At 2a, the MnS may send a CRR policy provisioning request to the ECS (e.g., as the CRR function). The CRR policy provisioning request may include CRR rule(s) to be included in the CRR policy of the ECS for EES instances that have been instantiated by the MnS. A CRR rule (e.g., each CRR rule) may include one or more of the following: the EESID of an EES that has been created by the MnS, a server set, an identifier of a server set, consumer resource information (e.g., type of resource, resource URI) that identifies consumer resource(s) (e.g., resources associated with the EESID that are to be managed via the CRR policy) and relocation information (e.g., information indicating how and where to relocate consumer resources)).

Upon receiving the CRR policy provisioning request at 2b, the ECS may authorize the request and save the CRR rules in the CRR policy. The ECS may validate the CRR rules according to one or more of the following: for example, the ECS may validate if the active server identifier of the CRR rule matches an EES registered at the ECS; the ECS may validate if the server set has been provided or if a server set can be retrieved if a server set identifier has been provided; the ECS may validate if consumer resource information and relocation information has been provided. The ECS may assign a CRR rule identifier and a CRR rule origin corresponding to the requestor that provided the CRR rule.

At 2c, the ECS may send a CRR policy provisioning response and/or may indicate a failure and a reason for a failure if the CRR rules validation has failed. If the request has been successful, the response may indicate CRR rules identifiers and a CRR policy identifier for future management of CRR policy and rules.

It may be appreciated that the CRR Function may receive CRR rules from other nodes (e.g., a WTRU, an EEC that is hosted by a WTRU, an ECS, or an EAS) to form a CRR policy.

It may further be appreciated that the resource granularity of the CRR rule depends on the originator of the rule. In examples, a CRR rule originating from the MnS may have a coarse granularity because the MnS does not have visibility on individual consumer resources of an EES. For example, the CRR rule may indicate relocating part of the consumer resources to alternate-server-1 and the remainder to alternate-server-2. In some examples, a CRR rule originating from the EES may have a fine granularity because the EES has full visibility on individual consumer resources of the EES. For example, the CRR rule may indicate to relocate consumer resources to alternate-server-1 and the other resources to alternate-server-2. In an example, granularity may be related to the specificity of the CRR rule. A CRR rule with coarse granularity may identify (e.g., only identify) types of resources or groups of resources. A CRR rule with fine granularity may identify specific resources. A CCR rule may have both fine granularity and coarse granularity.

A CRR policy may be updated. FIG. 4 illustrates an example CRR policy update. FIG. 4 presents an edge system where the CRR function may be provided by an ECS and where the CRR policy rules may be updated by the EES or the MnS. In examples, CRR rules may be updated to the ECS by the EES when a consumer (e.g., a new consumer) registers to the EES. In examples, CRR rules may be updated in the ECS by the MnS when a new EES becomes available.

Multiple CRR policy update embodiments may happen in the same system, for example, an EES may update the CRR rules of the ECS, and the MnS may update the CRR rules to the ECS.

At 1, a CRR policy may be updated by the EES. At 1a, a WTRU or EEC or EAS (e.g., as a consumer) may send a registration request to the active server (e.g., the EES). The registration request may include information about the WTRU, the EEC, or the EAS. At 1b, upon receiving the registration request, the EES may authorize the request and may store the consumer information provided in the request as a consumer resource (e.g., an EEC context may be created to store EEC information, or an EAS profile may be stored directly). The resources may be stored locally or on a shared storage. At 1c, the EES may send an EES registration update request to the CRR function (e.g., the ECS). The EES registration update request may include new CRR rules according to the newly created resources. In some examples, the EES registration update request may include an existing CRR rule (e.g., with CRR rule identifier) where newly created consumer resources are added.

At 1d, upon receiving the EES registration update request, the ECS may authorize the request and save the CRR rules in the CRR policy. The ECS may validate the CRR rules according to one or more of the following: the ECS may validate if the active server identifier of the CRR rule matches the registering EES; the ECS may validate if the server set has been provided or if a server set can be retrieved if a server set identifier has been provided; and the ECS may validate if consumer resource information and relocation information has been provided.

At 1e, the ECS may send an EES registration update response and/or may indicate a failure and a reason for a failure if the CRR rules validation has failed. If the request has been successful, the response may indicate CRR rules identifiers and a CRR policy identifier for future management of CRR policy and rules.

At 2, a CRR policy may be updated by the MnS. At 2a, the MnS may send a CRR policy update request to the ECS (e.g., as the CRR function). The CRR policy update request may include one or more CCR rules associated with the EES. The CRR policy update request may include new CRR rule(s) according to the newly created EES (e.g., as an active server) (or may include an existing CRR rule where newly created EES is added as an alternate server).

At 2b, upon receiving the CRR Policy update request, the ECS may authorize the request and save the CRR rules in the CRR policy. The ECS may validate the CRR rules according to one or more of the following: the ECS may validate if the active server identifier of the CRR rule matches an EES registered at the ECS, the ECS may validate if the server set has provided or if a server set may be retrieved if a server set identifier has provided, and the ECS may validate if consumer resource information and relocation information have been provided.

At 2c, the ECS may send a CRR policy update provisioning response, and/or may indicate a failure and a reason for a failure (e.g., failed authorization, failed CRR rules validation, etc.) if the CRR rules validation has failed. If the request has been successful, the response may indicate CRR rules identifiers and a CRR policy identifier for future management of CRR policy and rules.

It may be appreciated that the CRR Function may receive CRR rules updates from other nodes (e.g., a WTRU, an EEC, an ECS, an EAS, or an EEC) to form a CRR policy. The reasons for updating CRR rules vary (e.g., changes in consumer resources, changes in consumer resource allocation, changes in alternate server availability, etc.) and may be dependent on the CRR rules provider.

A CRR policy may be read and/or decoded. It may be appreciated that the CRR function may allow a CRR function client to obtain the CRR policy through an API. The API may include filters allowing a CRR function client to obtain a policy based on one or more of the following: to obtain a policy based on the provided CRR policy identifier, to obtain specific CRR rules according to the provided CRR rule identifier(s), and to obtain CRR rules according to the rule's provisioning source.

A CRR policy may be deleted. It may be appreciated that the CRR function may allow CRR function clients to delete the CRR policy through a provided API. The API may include filters that allow for the deletion of a policy based on one or more of the following: to delete a policy based on the provided CRR policy identifier, to delete specific CRR rules according to the provided CRR rule identifier(s), and to delete CRR rules according to the rule's provisioning source.

A CRR policy may be applied according to one or more examples herein. FIG. 5 illustrates an example CRR policy and function system overview. FIG. 5 presents an overview of an edge system where the CRR function may be provided by an ECS and where the CRR policy rules may have been provided by the EES active server and the MnS. The MnS is not shown in FIG. 5.

The EES active server 0518 may manage resources for WTRU consumers 0510 and EAS consumers 0514. The EES resources may be saved on a shared storage 0526 (e.g., a shared storage which is accessible by the EES active server instance 0518 as well as the EES alternate server instance(s) 0528 and/or 0530). In examples, the consumer resources may be created, pushed to the shared storage 0526, and/or managed by the EES active server 0518 directly from the shared storage 0526.

The EES active server 0518 may provide a CRR rule to the ECS CRR function 0522. In examples, the rule may contain the EES active server identifier (e.g., EESID), a server set including 0528 EES alternate server-1 and 0530 EES alternate server-2, the WTRU and EAS consumer resources information (e.g., type and URI) available on the shared storage 0526, and a relocation rule indicating to distribute consumer resources (e.g., equally) between alternate servers (e.g., 0528 EES alternate server-1 and 0530 EES alternate server-2) of the server set (e.g., when the EES active server 0518 becomes unavailable).

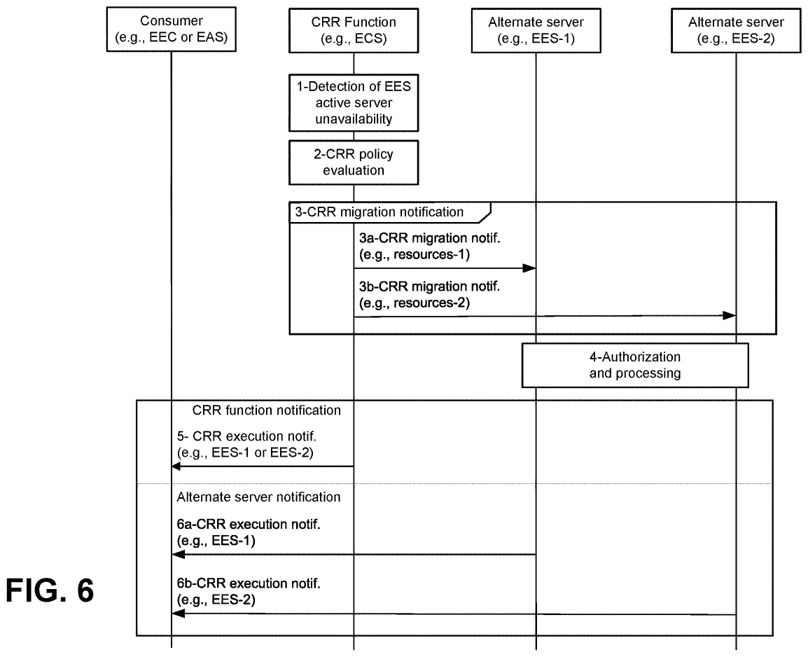

A device (e.g., a CRR function) may detect unavailability, evaluate CRR policy rules associated with the unavailable server to identify an alternate server for a (e.g., each) migrated resource, send a CRR migration notification to the identified alternate server(s), receive a CRR migration authorization, notify service consumers (e.g., WTRU and/or EAS) of the alternate server migration. The CRR migration notification may trigger the alternate servers to notify their respective service consumers (e.g., WTRU and EAS) of the alternate server migration. FIG. 6 illustrates an example of consumer resource relocation using a CRR policy. FIG. 6 presents a procedure related to the edge system of FIG. 5.

At 1, the ECS (e.g., as a CRR function) may detect the unavailability of the EES active server. This detection may trigger the relocation of the EES active server consumer resources. Detecting the unavailability of the EES active server may be one example of a triggering event.

At 2, upon detecting the EES active server unavailability, the ECS may evaluate CRR rules of the CRR policy for the active server associated with the triggering event. The CRR function may use the active server identifier of a CRR rule (e.g., each CRR rule) to identify CRR rules that are applicable to the triggering event (e.g., CRR rules that are not applicable to the active server of the triggering event are not considered for consumer resource relocation related to the triggering event).

The ECS may obtain a server set, for example, by using the server set identifier included in the CRR rule being evaluated. In some examples, the CRR rule may contain a server set.

The CRR function may use the server set to identify the alternate servers that are to be considered for consumer resource relocation. The CRR function may identify the alternate servers, for example, using the additional information of the CRR rule or of the server set. For example, the CRR function may consider one or more of the following: may consider whether the ECSP of the alternate server is valid for relocating consumer resources, may consider whether the topological and/or geographical service area of the alternate server is valid for relocating consumer resources, and may consider whether the time period associated with the alternate server is valid for relocating consumer resources. The CRR function may also consider whether the server load of the alternate server allows for relocating consumer resources.

If the CRR function does not identify any severs (e.g., alternate servers) for a CRR rule, the CRR rule may not be considered for consumer resource relocation related to the triggering event. In examples, if the CRR function does not identify any alternate servers for a CRR rule, the ECS may determine a server (e.g., an alternate server). The absence of servers (e.g., alternate servers) for a CRR rule may be an indication to the ECS that the ECS is to determine the identity of an alternate server.

The ECS may have identified one or more CRR rules that are applicable for consumer resource relocation, for example, at the end of the CRR policy evaluation. If no rules have been identified, consumer resource relocation may not be possible and, in examples, the ECS may notify consumers that resource relocation is not possible as shown at 5.

The ECS may perform resource assignment of consumer resources to one or more alternate servers, for example, considering the applicable CRR rules.

At 3, upon completing resource assignment, if consumer resources have been assigned to one or more servers (e.g., alternate servers), the ECS may send CRR migration notification(s) (e.g., one CRR migration notification to each of the identified EES alternate servers (shown in 3a, 3b). A CRR migration request may be sent (e.g., equivalently if notifications are not used). A CRR migration notification may contain consumer resource(s) information (e.g., each CRR migration notification may contain only the consumer resource(s) information that have been assigned to the alternate server for which the notification is sent).

At 4, upon receiving the CRR migration notification, the EES servers (e.g., alternate servers, each of the EES alternate servers) may onboard the consumer resources and start managing the consumer resources identified in the notification. The onboarded resources (e.g., newly onboarded resources) may be integrated with other resources (e.g., the pre-existing consumer resources, if any). For a server (e.g., an alternate server), onboarding consumer resources may include starting to manage the provided consumer resource and may include performing one or more of other tasks, for example, monitoring such consumer resources, updating consumer resources with information related to the server (e.g., alternate server) starting to monitor events related to subscriptions associated with such consumer resources, subscribing for core network events related to such resources (for example, monitoring WTRU location), and/or starting performing ACR processing depending on such a resource configuration. The information related to the server may includes IP addresses, URI, FQDN, security credentials, a combination thereof, and the like.

In examples, such as shown at 5, the ECS may send a CRR execution notification (e.g., to one or more of the following: the WTRU, EEC, and/or EAS consumer nodes) to indicate the new active server.

The notification may identify consumer resources related to the consumer, and/or may indicate the new active server managing these resources (e.g., EES-1 or EES-2).

In examples, such as shown at 6, the EES alternate server may send a CRR execution notification (e.g., to one or more of the following: the WTRU, EEC, and/or EAS consumer nodes) to indicate the new active server. The notification may identify consumer resources related to the consumer and/or may indicate the new active server managing these resources (e.g., the notification may identify EES-1 or EES-2).

In examples, a device (e.g., a CRR function) may determine that a first server has become unavailable to manage a plurality of consumer resources, determine, based on one or more CRR rules of a CRR policy associated with the first server, a management distribution scheme associated with a server set (e.g., the server set comprises one or more alternative servers to the first server), determine, based on the management distribution scheme, a second server of the server set to manage a set of inter-related consumer resources of the plurality of consumer resources, send, to the second server, a request to manage the set of inter-related consumer resources, receive, from the second server, an authorization of the request, and send notification information to service consumers associated with the set of inter-related resources.

Inter-related resources (e.g., inter-dependent edge resources) may be used in one or more examples herein. Inter-relation of resources (e.g., consumer resources) may include inter-dependent resources affinity and/or anti-affinity. In examples, certain inter-dependent resources may remain co-located (e.g., may need to remain co-located, for example, to preserve functionality, performance, or characteristics as described in one or more examples described herein). The procedure as described in one or more examples herein (e.g., the example shown in FIG. 6) may be changed to preserve the co-location of inter-dependent consumer resources (e.g., because the CRR function may not be aware of resource inter-dependencies). In some examples (e.g., as shown in FIG. 5), the ECS may not have access to the EES shared storage and may not be able to interpret consumer resource information present in the shared storage. In some examples, the CRR function may access and/or understand consumer resources of the shared storage. In some instances, if the CRR function accesses and understands consumer resources of the shared storage, inspecting such a large amount of data to identify inter-dependent resources may be time-consuming and/or may cause a reliability failure.

In examples, CRR rules may include inter-relation information (e.g., resource affinity information). For example, resource affinity information may indicate (e.g., to the CRR function) that consumer resources from different consumers may need to be co-relocated together to the same server (e.g., the same alternate server). A device (e.g., a CRR function) may determine a management distribution scheme based on the inter-relation information. For example, the consumer resources (e.g., from different consumers) used by the same consumer may be inter-related. In the scenario where an EAS bundle (e.g., a group of EASs) is used by a WTRU, the consumer resources of certain EASs (e.g., EASs mirrors) of the EAS bundle may be inter-dependent (e.g., the consumer resources of EAS mirrors may be used by the same consumer) and may be relocated to the same alternate server(s) (e.g., may need to be relocated to the same alternate server(s) to provide equivalent connectivity performance).

In examples, CRR rules may include resource anti-affinity information (e.g., resource anti-affinity rules). A device (e.g., a CRR function) may determine a management distribution scheme based on the resource anti-affinity information. For example, resource anti-affinity information may indicate (e.g., to the CRR function) that certain resources may not be co-relocated together to the same server (e.g., the same alternate server). In examples, the resource anti-affinity information may indicate a restriction that restricts these resources from being co-relocated together to the same server. For example, in the scenario where a redundant backup server (e.g., a mirror server) may be used, the consumer resources of a server and the redundant backup server for the server (e.g., the consumer resources of both mirrors) are inter-related (e.g., resources from the same consumer are inter-dependent) but may need to be relocated to two different servers (e.g., alternate servers) to provide redundancy.

Inter-relation (e.g., affinity or anti-affinity of consumer resources) may be indicated (e.g., by the provider of the CRR rule(s), following one or more of the examples as described herein. In examples, consumer resource information (e.g., consumer resource information as indicated in the CRR rule(s)) may be augmented with an inter-relation indicator (e.g., a resource affinity or anti-affinity information element). For example, a first inter-relation indicator associated with a first consumer resource and a second inter-relation indicator associated with a second consumer resource may indicate whether the first consumer resource and the second consumer resource are inter-related. For example, the first inter-relation indicator and the second inter-relation indicator may include a resource affinity information element (e.g., the same resource affinity information element indicating that the first consumer resource and the second consumer resource are to be managed by the same server). The first inter-relation indicator and the second inter-relation indicator may include a resource anti-affinity information element (e.g., the same anti-affinity information element indicating that the first consumer resource and the second consumer resource are to be managed by two different servers).

Resources associated with different consumers marked with the same affinity value may be considered as inter-dependent consumer resources (e.g., by the CRR function) and may need to be co-relocated accordingly. In examples, if a first affinity value (e.g., as indicated by the first inter-relation indicator) of a first consumer resource is the same as a second affinity value (e.g., as indicated by the second inter-relation indicator) of a second consumer resource, the first consumer resource and the second consumer resource are to be managed by the same server, for example, as indicated by a management distribution scheme.

Resources associated with different consumers marked with the same anti-affinity value may be considered as inter-dependent consumer resources (e.g., by the CRR function) and may need to be relocated to different alternate servers accordingly. In examples, if a first anti-affinity value (e.g., as indicated by the first inter-relation indicator) of a first consumer resource is the same as a second anti-affinity value (e.g., as indicated by the second inter-relation indicator) of a second consumer resource, the first consumer resource and the second consumer resource are to be managed by a first server and a second server, respectively, for example, as indicated by a management distribution scheme.

One or more examples as described herein may allow a system to use a CRR rule (e.g., a single CRR rule) for the consumer resources (e.g., all consumer resources), and/or one or more inter-dependencies may be indicated in the CRR rule (e.g., defined in the single CRR rule) by using different resource affinity or anti-affinity values.

Different consumer resources may be associated with different CRR rules. In examples, inter-dependent consumer resources may be managed according to their respective CRR rules (e.g., the provider of the CRR rule(s) may choose to segregate inter-dependent consumer resources in their respective CRR rules). A CRR rule may contain consumer resource information (e.g., only consumer resource information) that is commonly inter-dependent. In examples, a first consumer resource may be associated with a first CRR rule (e.g., a first CRR rule of a CRR policy), and a second consumer resource may be associated with a second CRR rule (e.g., a second CRR rule of the CRR policy). If the first CRR rule and the second CRR rule include common consumer resource information, a management distribution scheme may indicate that a server (e.g., an alternative server) is to manage the first consumer resource and the second consumer resource. For example, CRR rule relocation information may indicate relocating these resources to the same alternate server (e.g., for an affinity case). Different CRR rules may be used for inter-related consumer resources that may need to be relocated to different servers (e.g., alternate servers). For example, different CRR rules may be used for an anti-affinity case. In examples, if the first CRR rule and the second CRR rule do not include common consumer resource information, a management distribution scheme may indicate that a first server of the server set is to manage the first consumer resource and that a second server of the server set is to manage the second consumer resource. This approach may need to use several CRR rules (e.g., one for each inter-dependent consumer resource) and/or may allow an easier management of CRR rules for inter-dependent resources.

One or more examples herein (e.g., the examples where consumer resource information may be augmented with a resource affinity or anti-affinity information element, and examples where the provider of the CRR rule(s) may choose to segregate inter-dependent consumer resources in their respective CRR rules) may be used concurrently in a CRR policy. In examples, the procedure for inter-dependent consumer resource relocation may be the same as presented in FIG. 6.

Inter-dependent resources may be separated. In some scenarios, it may not be possible to relocate inter-dependent resources to the same alternate server. For example, if two WTRUS independently use the same EAS, but cannot be relocated to the same alternate EES (e.g., due to service area or other inter-dependencies), it may not be possible to relocate them to the same alternate server.

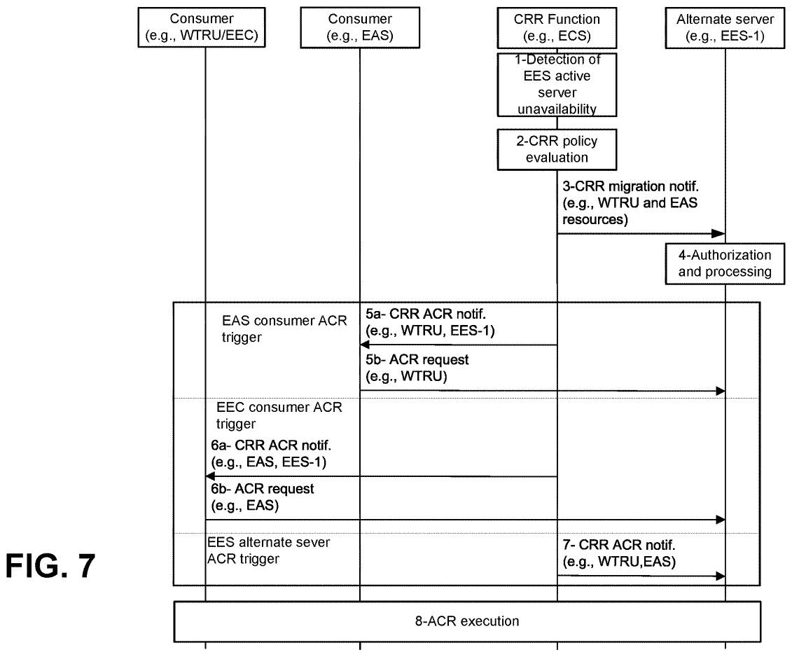

A device (e.g., a CRR function) may use the service continuity capabilities of an edge system (e.g., a 5G edge system) to trigger application context relocation (e.g., to resolve the inter-dependency issue when an inter-dependent consumer resource cannot be migrated together). FIG. 7 illustrates an example of inter-dependent consumer resource separation. FIG. 7 presents a procedure related to the edge system of FIG. 5. For example, in FIG. 7, the WTRU and EAS may have an inter-dependency (e.g., an inter-dependency that cannot be resolved and/or require CRR function ACR triggering).

At 1, the ECS (e.g., as a CRR function) may detect the unavailability of the EES active server to trigger relocation of the EES active server consumer resources. At 2, upon detecting the EES active server unavailability, the ECS may evaluate the CRR rules (e.g., all CRR rules) of the CRR policy for the active server associated with the triggering event (e.g., as at 2 of FIG. 6). The CRR function may detect an unresolvable inter-dependency between the WTRU and EAS while performing resource assignment. At 3, upon completing the resource assignment, the ECS may send a CRR migration notification to the alternate server EES-1 (e.g., as at 2 of FIG. 6). Consumer resources of the WTRU and the EAS are temporarily migrated to EES-1 in preparation for triggering an ACR. In examples, the CRR function may combine the CRR migration notification at 3 and CRR ACR notification at 7 to indicate in the CRR migration notification (e.g., at 3) that EES-1 is to trigger an ACR for the WTRU and EAS to avoid sending the CRR ACR notification at 7, considering the ACR procedures supported by the WTRU, EAS, and EES-1. At 4, upon receiving the CRR migration notification, the EES alternate server may onboard the consumer resources and start managing the consumer resources identified in the notification (e.g., as at 4 of FIG. 6).

In examples, such as at 5a, considering the ACR capabilities of the WTRU, EAS, and EES-1 and the ACR selection, the ACR function may send a CRR ACR notification at 5a to the EAS. The CRR ACR notification may provide a WTRU or EEC identifier and the EESID of EES-1. At 5b, upon receiving the notification, the EAS may trigger the ACR procedure by sending an ACR request at 5b to EES-1. The ACR request may provide the WTRU or EEC identifiers received in the CRR ACR notification and/or may trigger ACR execution. The CRR ACR notification may be a CRR ACR request, for example, if a subscription/notification mechanism is not used. At 6a, considering the ACR capabilities of the WTRU, the EAS, and EES-1 and the ACR selection result, the ACR function may send a CRR ACR notification at 6a to the WTRU. The CRR ACR notification may provide at least one of the EAS identifier, EAS endpoint, or the EESID of EES-1. At 6b, upon receiving the notification, the WTRU may trigger the ACR procedure by sending an ACR request at 6b to EES-1. The ACR request may provide the EASID and/or EAS endpoint received in the CRR ACR notification and/or may trigger ACR execution. At 7, considering the ACR capabilities of the WTRU, EAS, and EES-1 and the ACR selection result, the ACR function may send a CRR ACR notification to EES-1 at 7. The ACR notification may provide: the EAS identifier; EAS endpoint; WTRU or EEC identifier. Upon receiving the notification, EES-1 may trigger ACR execution. At 8, if ACR execution has been triggered at 5, 6, 7, or 3, execution of the ACR procedure may result in re-selection of a target EES and/or target EAS, the EEC context and/or application context may be relocated to the target EES and target EAS respectively, and/or the user session may continue using the newly selected target EAS. The interdependency issue may be resolved.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A device, comprising:
a processor configured to:
determine that a plurality of consumer resources is to be managed by one or more servers of a server set;
determine, based on one or more consumer resource relocation (CRR) rules of a CRR policy, a first inter-relation indicator associated with a first consumer resource of the plurality of consumer resources and a second inter-relation indicator associated with a second consumer resource of the plurality of consumer resources, wherein the first and second inter-relation indicators indicate whether the first and second consumer resources are inter-related, and wherein the first consumer resource is associated with a first service consumer, and the second consumer resource is associated with a second service consumer;
determine a management distribution scheme associated with the one or more servers of the server set based on the first and second inter-relation indicators; and
send notification information to the first service consumer and the second service consumer, wherein the notification information indicates the management distribution scheme.

2. The device of claim 1, wherein the management distribution scheme indicates that a server from the server set is to manage at least one of the first consumer resource or the second consumer resource.

3. The device of claim 1, wherein the CRR policy is associated with a first server, and the one or more servers are alternative servers to the first server.

4. The device of claim 1, wherein the first inter-relation indicator is a first affinity value, and the second inter-relation indicator is a second affinity value, and, on a condition that the first affinity value is the same as the second affinity value, the management distribution scheme indicates that a server of the server set is to manage the first and second consumer resources.

5. The device of claim 4, wherein the processor is further configured to:
determine, based on the management distribution scheme, the server of the server set;
send, to the server, a request to manage the first and second consumer resources of the plurality of consumer resources; and
receive, from the server, an authorization of the request.

6. The device of claim 1, wherein the first inter-relation indicator is a first anti-affinity value, and the second inter-relation indicator is a second anti-affinity value, and, on a condition that the first anti-affinity value is the same as the second anti-affinity value, the management distribution scheme indicates that a first server of the server set is to manage the first consumer resource and that a second server of the server set is to manage the second consumer resource, and wherein the first server and the second server are different.

7. The device of claim 1, wherein the first inter-relation indicator is a first anti-affinity value, and the second inter-relation indicator is a second anti-affinity value, and, on a condition that the first anti-affinity value is the same as the second anti-affinity value, the notification information comprises a CRR application context relocation (ACR) triggering message indicating a relocation of an application context associated with at least one of the first service consumer or the second service consumer.

8. The device of claim 1, wherein the first consumer resource is associated with a first CRR rule of the one or more CRR rules of the CRR policy, and the second consumer resource is associated with a second CRR rule of the one or more CRR rules, wherein, on a condition that the first CRR rule and the second CRR rule comprise common consumer resource information, the management distribution scheme indicates that a server of the server set is to manage the first and second consumer resources.

9. The device of claim 1, wherein the first consumer resource is associated with a first CRR rule of the one or more CRR rules of the CRR policy, and the second consumer resource is associated with a second CRR rule of the one or more CRR rules, wherein, on a condition that the first CRR rule and the second CRR rule do not comprise common consumer resource information, the management distribution scheme indicates that a first server of the server set is to manage the first consumer resource and that a second server of the server set is to manage the second consumer resource.

10. The device of claim 1, wherein the CRR policy is associated with a first server and indicates a way in which the management of the plurality of consumer resources is to be distributed among the one or more servers of the server set when the first server becomes unavailable to manage the plurality of consumer resources.

11. The device of claim 1, wherein the first service consumer is an edge enabler client (EEC), and the first consumer resource comprises EEC context information, or the first service consumer is an edge application server (EAS) and the first consumer resource comprises EAS profile information.

12. The device of claim 1, wherein the notification information indicates a reassignment of the management of the plurality of consumer resources.

13. A method, comprising:
determining that a plurality of consumer resources is to be managed by one or more servers of a server set;
determining, based on one or more consumer resource relocation (CRR) rules of a CRR policy, a first inter-relation indicator associated with a first consumer resource of the plurality of consumer resources and a second inter-relation indicator associated with a second consumer resource of the plurality of consumer resources, wherein the first and second inter-relation indicators indicate whether the first and second consumer resources are inter-related, and wherein the first consumer resource is associated with a first service consumer, and the second consumer resource is associated with a second service consumer;
determining a management distribution scheme associated with the one or more servers of the server set based on the first and second inter-relation indicators; and
sending notification information to the first service consumer and the second service consumer, wherein the notification information indicates the management distribution scheme.

14. The method of claim 13, wherein the management distribution scheme indicates that a server from the server set is to manage at least one of the first consumer resource or the second consumer resource.

15. The method of claim 13, wherein the CRR policy is associated with a first server, and the one or more servers are alternative servers to the first server.

16. The method of claim 13, wherein the first inter-relation indicator is a first affinity value, and the second inter-relation indicator is a second affinity value, and, on a condition that the first affinity value is the same as the second affinity value, the management distribution scheme indicates that a server of the server set is to manage the first and second consumer resources.

17. The method of claim 13, further comprising:
determining, based on the management distribution scheme, the server of the server set;
sending, to the server, a request to manage the first and second consumer resources of the plurality of consumer resources; and
receiving, from the server, an authorization of the request.

18. The method of claim 13, wherein the first inter-relation indicator is a first anti-affinity value, and the second inter-relation indicator is a second anti-affinity value, and, on a condition that the first anti-affinity value is the same as the second anti-affinity value, the management distribution scheme indicates that a first server of the server set is to manage the first consumer resource and that a second server of the server set is to manage the second consumer resource, and wherein the first server and the second server are different.

19. The method of claim 13, wherein the first inter-relation indicator is a first anti-affinity value, and the second inter-relation indicator is a second anti-affinity value, and, on a condition that the first anti-affinity value is the same as the second anti-affinity value, the notification information comprises a CRR application context relocation (ACR) triggering message indicating a relocation of an application context associated with at least one of the first service consumer or the second service consumer.

20. The method of claim 13, wherein the first consumer resource is associated with a first CRR rule of the one or more CRR rules of the CRR policy, and the second consumer resource is associated with a second CRR rule of the one or more CRR rules, wherein, on a condition that the first CRR rule and the second CRR rule comprise common consumer resource information, the management distribution scheme indicates that a server of the server set is to manage the first and second consumer resources.
